(19) United States
(12) Patent Application Publication
(10) Pub. No.: US 2007/0072994 A1
(43) Pub. Date: Mar. 29, 2007

(54) Die-cuttable acrylic sheet

(76) Inventors: Leslie Cohen, Langhorne, PA (US); Elizabeth Grimes, Souderton, PA (US); Randall Miller, Glenmore, PA (US); Manuel Garcia-Leiner, Newtown, PA (US); Jack Reilly, Blue Bell, PA (US)

Correspondence Address: Thomas F. Roland, Esq.;Arkema Inc., 2000 Market St., Philadelphia, PA, 19103, US

(21) Appl. No.: 11/236,146

(22) Filed: Sep. 27, 2005

(51) Int. Cl. C08L 51/00

(52) U.S. Cl. 525/70

(57) ABSTRACT

The invention relates to an acrylic sheet that can be die-cut without cracking, yet has low temperature impact resistance and good weatherability. Specifically, the acrylic sheet is an impact modified copolymer having a matrix with a Tg of between 70 and 86° C. In a preferred embodiment the matrix is a copolymer of methyl methacrylate and from 12 to 18 percent by weight of ethyl acrylate.

### FIELD OF THE INVENTION

The invention relates to an acrylic sheet that can be die-cut without cracking, yet has low temperature impact resistance and good weatherability. Specifically, the acrylic sheet is an impact modified copolymer having a matrix with a Tg of between 70 and 86° C. In a preferred embodiment the matrix is a copolymer of methyl methacrylate and from 12 to 18 percent by weight of ethyl acrylate.

### BACKGROUND OF THE INVENTION

Acrylic compositions and articles made from them are well known for their clarity, sparkling color, surface gloss and weather resistance. They are also well known for their low impact strength or brittleness.

In the fabrication of plastic sheet into products, one common quick and economical mechanical process is that of die-cutting. Die-cutting is commonly used in the fabrication of parts from plastic sheet and rollstock for applications such as point-of purchase displays. While acrylics have many desirable properties for use in in-mold decorating, such as appearance and weatherability, they suffer from the inability to be die-cut without undergoing brittle fracture. Brittle fracture produces chips and cracks which preclude its use in these applications. It is desired to have a composition with all of the beneficial properties of acrylics that is ductile enough to be die-cut without cracking.

There are many factors which determine the properties of an impact modified acrylic sheet, including the composition of the matrix polymer, and for the impact modifier the number of layers in each stage, the thickness and construction of each layer, the monomer composition of each layer, the type and degree of crosslinking of each layer, the type and degree of grafting, as well as the concentration of the sequentially polymerized core/shell impact modifier in the matrix or primary polymer. The matrix polymer or primary polymer as defined herein is the polymer which forms the bulk of the articles, such as acrylic sheet, or an extruded capstock.

Capstocks based on low Tg and low molecular weight acrylic copolymers are disclosed in WO 00/08098 as having good weathering and impact strength.

U.S. Pat. No. 5,726,245 describes impact resistant molding compositions using a matrix acrylic polymer having 96% methyl methacrylate and 4 percent ethyl acrylate.

Traditional impact modified acrylics do not have the necessary toughness for some applications where high impact strength is important. These applications require the use of other polymers such as polycarbonate or polyethylene terephthalate glycol-modified (PETG) which, while tougher than standard impact modified acrylics, do not have the weatherability, or aesthetics of acrylics.

There is a need in the marketplace for an acrylic product that is die-cuttable, has good optical properties, and good long term weatherability—especially compared to either PETG or PC.

US 2003-0216510 discloses a weather-resistant, high-impact strength acrylic composition having at least 15 percent of an alkyl acrylate in the matrix polymer (and exemplified at 25% ethyl acrylate), and having a core-shell impact modifier in which the elastomer has a lower Tg. Unfortunately, the high levels of ethyl acrylate tend to decrease the chemical resistance and heat deflection temperature of the acrylic.

Surprisingly it has been found that a die-cuttable acrylic sheet can be produced within a selected narrow Tg range (within a specified range of acrylic compositions) having an excellent combination of properties including: good chemical resistance, high optical quality, low yellowness, good edge color, good low temperature impact strength, weatherability, and good flexibility.

### SUMMARY OF THE INVENTION

The invention relates to a die-cuttable acrylic sheet comprising:
a) from 40-60 percent by weight of an acrylic matrix copolymer comprising at least 60 percent by weight of methyl methacrylate units and 4-40 percent by weight of at least one C₁₋₈ straight chain or branched alkyl (meth)acrylate; and
b) from 40 to 60 percent by weight of at least one impact modifier;
wherein the Tg of the acrylic matrix copolymer is from 70° C. to 86° C.

### DETAILED DESCRIPTION OF THE INVENTION

By “die cuttable” or “die cuttability”, as used herein, is meant that the acrylic sheet is able to be cut with a die punch press without cracking and with little or no stress whitening.

The die-cuttable acrylic sheet of the invention comprises two polymeric components: 1) an acrylic copolymer matrix of methyl methacrylate and ethyl acrylate having between 12 and 18% ethyl acrylate and 2) an elastomeric impact modifier component.

The acrylic copolymer matrix of the invention is synthesized from at least 60% by weight of methyl methacrylate monomer and at least one other C₁₋₈ straight chained or branched alkyl (meth)acrylate monomer. The copolymer matrix will have a Tg of from 70° C. to 86° C., and preferably from 74° C. to 84° C.

In one embodiment, the acrylic copolymer matrix of the invention consists of 82-88 weight percent methyl methacrylate units and 12-18 weight percent of ethyl acrylate units. Higher levels of ethyl acrylate in the acrylic matrix lead to reduced chemical resistance and decreased heat distortion, while lower levels produce a sheet that suffers from a loss of die-cuttable properties. The molecular weight of the copolymer is in the range of 50,000 to about 250,000 daltons. Preferably the molecular weight is from 100,000 to 190,000 daltons. Matrix acrylic copolymers having higher molecular weights may provide better chemical resistance and heat distortion, while retaining die-cuttability. The acrylic copolymer matrix can be prepared by any standard method of preparing copolymers of methacrylates and acrylates, include bulk, solvent, and emulsion polymerization.

Rubber toughened acrylic resins are widely used in applications where the beneficial properties of acrylics (clarity, weathering, etc.) are desired, but where standard unmodified acrylic resins lack the desired level of impact toughness. The usual way of rubber toughening an acrylic resin is by incorporating impact modifier into the acrylic matrix.

Preferred impact modifiers are core-shell multi-stage polymers and block copolymers having at least one hard and at least one soft block. The core-shell impact modifiers could have a soft (rubber or elastomer) core and a hard shell, a hard core covered with a soft elastomer-layer, and a hard shell, of other core-shell morphology known in the art. The rubber layers are composed of low glass transition (Tg) polymers, including, but not limited to, butyl acrylate (BA), ethylhexyl acrylate (EHA), butadiene (BD), butadiene/styrene, and butylacrylate/styrene.

The preferred glass transition temperature (Tg) of the elastomeric layer should be below 25° C. The elastomeric or rubber layer is normally crosslinked by a multifunctional monomer for improved energy absorption. Crosslinking monomers suitable for use as the crosslinker in the core/shell impact modifier are well known to those skilled in the art, and are generally monomers copolymerizable with the monounsaturated monomer present, and having ethylenically multifunctional groups that have approximately equal reactivity. Examples include, but are not limited to, divinylbenzene, glycol of di- and trimethacrylates and acrylates, triol triacrylates, methacrylates, and allyl methacrylates, etc. A grafting monomer may also be used to enhance the interlayer grafting of impact modifiers and the matrix/modifier particle grafting. The grafting monomers can be any polyfunctional crosslinking monomers.

For soft core multi-layered impact modifiers, the core ranges from 30 to 85 percent by weight of the impact modifier, and outer shells range from 15-70 weight percent. The crosslinker in the elastomeric layer ranges from 0 to 5.0%. The synthesis of core-shell impact modifiers is well known in the art, and there are many references, for example U.S. Pat. No. 5,063,259, incorporated herein by reference. The refractive index of the modifier particles, and the matrix polymer, can be matched to each other by using copolymerizable monomers with different refractive indices.

In a preferred embodiment, a 3-stage core-shell impact modifier having an intermediate (elastomeric) layer making up 30 to 45 percent of the impact modifier is used.

The impact modifier generally has an average particle size of from 300-450 nm. In one embodiment it was found to be useful to use impact modifiers having a particle size average below about 150 nm. The smaller size impact modifier can lead to improved chemical resistance and clarity.

In addition to impact modifiers, the die-cuttable sheet of the invention may contain up to about 1 percent of other typical additives, such as anti-oxidants, UV absorbers, lubricants, colorants and dyes. In one embodiment, phosphorous-containing anti-oxidants are used.

The die cuttable sheet is formed by means known in the art. In one embodiment the matrix polymer, impact modifiers and other additives are melt-blended in a twin-screw extruder into a single resin that is pelletized into granules. The polymeric granules are then subsequently extruded into polymeric sheet. The sheet or film of the invention can also be formed by a casting process, such as a solvent cast process.

The die cuttable sheet has a thickness of from 0.003 to 0.177 inches and preferably from 0.020 to 0.125 inches.

The die cuttable acrylic sheet of the invention can be die cut at thinner gauges and maintain a greater amount of impact strength at low temperatures. It also surpasses both PC and PETG in weatherability, so that it is more versatile, being able to be used in outdoor as well as indoor applications. The product also offers slightly higher DTUFL than general purpose PETG, making it more stable for shipping and outdoor use.

The die-cuttable acrylic sheet of the invention can be used in many applications, including but not limited to: in-mold-decorating; general purpose point of purchase applications; fixtures; marine glazing; and high performance uses, such as snow mobile windscreens and signs.

### EXAMPLES

### Example 1

The following components were twin-screw extrusion blended:
49 wt % P(methyl methacrylate/ethyl acrylate) containing 15 wt % ethyl acrylate 50 wt % multistage butyl acrylate (BA) based impact modifier with a hard core and 4 stages with the following weight %: 38 hard stage//35.9 elastomeric stage (BA based)//18.8 elastomeric stage (BA based)//7.2 hard stage, and with an average particle size of about 300, according to U.S. Pat. No. 3,793,402, incorporated herein by reference.

### Example 2

Impact modified acrylic resin was extruded at about 460° F. with a die temperature of about 500° F. to form a 0.118 inch thick sheet having the following composition:

2A (invention)=matrix of 15% ethyl acrylate and 85% methyl methacrylate, Mw of about 125,000

2B (comparative)=matrix of 25% ethyl acrylate and 75% methyl methacrylate, Mw of about 190,000.

Sample 2C (comparative) is 0.118 inch thick VIVAK PETG from Bayer. Properties of each of these sheets were measured using the ASTM method indicated, with the results in TABLE 1.

TABLE 1

| | ASTM | | | | |
|---|---|---|---|---|---|
| PROPERTY | METHOD | UNITS | Sample 2A | Sample 2B | Sample 2C |
| Transmission | D-1003 | % | 91.1 | 88.3 | 88 |
| Dynatup Energy 0° C. | D-3763 | | | | |
| First Break Energy | | ft-lbs | 4.1 | 4.8 | 1.1 |
| Max. Load Energy | | ft-lbs | 4.1 | 4.8 | 1.8 |
| Total | | ft-lbs | 4.2 | 5.7 | 3.0 |
| DTUFL (samples | D-648 | | | | |
| annealed) | | | | | |
| @66 psi | | C./F. | 85.5/185.8 | 67.8/154.0 | 80.2/176.4 |
| @264 psi | | C./F. | 78.9/174 | 63.1/145.7 | 77.9/172.2 |
| Constant Stress Craze | ARTC Mod | psi | 680 | 375 | 1425 |
| Resistance, isopropyl | MIL-P-6997 | | | | |
| Alcohol (IPA) | | | | | |
| Constant Strain (IPA) | Span length 16 in. | sec | >600 | 130 | >600 |
| 0.25% | Arc length 16.32 in | | | (whitened in | |
| | Radius of | | | 94 sec) | |
| | Curvature = 26.6 in | | | | |

### Example 3

Xenon Arc Weathering (ASTM G155 Cycle 2 was performed on 0.080 inch thick samples of the acrylic sheet with the composition of Example 2A (invention)=3A and the VIVAK PETG of Example 2C=3C (Comparative), with the results shown in Table 2.

TABLE 2

| SAMPLE | HOURS | % LT | % HAZE | Delta % LT | Delta % Haze |
|---|---|---|---|---|---|
| 3A | 0 | 91.81 | 3.45 | 0 | 0 |
| 3C | 0 | 88.32 | 2.45 | 0 | 0 |
| 3A | 1000 | 91.61 | 3.45 | 0.2 | 0.09 |
| 3C | 1000 | 88.05 | 3.62 | 0.27 | 1.17 |
| 3A | 2000 | 91.61 | 3.56 | 0.2 | 0.11 |
| 3C | 2000 | 85.19 | 59.9 | 3.13 | 57.45 |
| 3A | 3000 | 91.05 | 3.43 | 0.76 | 0.02 |
| 3C | 3000 | 83.82 | 87.5 | 4.5 | 85.05 |
| 3A | 5000 | 89.05 | 5.46 | 2.76 | 2.01 |
| 3C | 5000 | 52.8 | 100 | 35.52 | 97.55 |
| 3A | 6000 | 87.59 | 4.21 | 4.22 | 0.76 |
| 3C | 6000 | 42.46 | 100 | 45.86 | 97.55 |

In the below table 3 we tested the relative die-cuttability of the invention versus standard impact acrylic PLEXIGLAS DR-101 (Arkema Inc.) on extruded sheet thicknesses of 0.118 inches and 0.080 inches. We used a standard commercially available die-cutting machine used in the industry to cut PETG for our testing. It is obvious from the table that the 4A sample (invention) affords a much smoother die-cuttable edge after die-cutting versus the comparative acrylic control.
4A (Invention)
4B (Comparative)-PLEXIGLAS DR101

### Example 4

The relative die-cuttability was tested on 0.118 and 0.080 inch thick extruded sheets. Samples were die cut on a commercially available die-cutting machine (100 ton Thompson using a standard steel rule die), with the data given in TABLE 3. From the data it can be seen that sample 4A (15% EA/85% MMA—invention) affords a much smoother die-cuttable edge after die-cutting compared to sheet 4B (4% EA/94% MMA—comparative)

TABLE 3

| | 4A | 4B | 4A | 4B |
|---|---|---|---|---|
| Material | Invention | Comparative | Invention | Comparative |
| Sheet | 0.118 inches | 0.118 inches | 0.080 inches | 0.080 inches |
| thicknesses | | | | |
| Die-cut Edge | Smooth | Chipped and | Smooth | Chipped and |
| | | cracked | | cracked |

### Example 5

### Calculated Tg

The Table below represents calculated glass transition (Tg) temperatures for copolymers of ethyl acrylate and methyl methacrylate at various ratios. The Tgs were calculated using the Fox equation:
1/Tg=Wₐ/T_{ga}+W_{b}/T_{gb}
where T_{ga} and T_{gb}=the glass transition temperatures of polymers “a” and “b” (Tga for polymethylmethacrylate=278° K, Tgb for poly ethyl methacrylate=251° K)

Wₐ and W_{b}=the weight fraction of polymers “a” and “b”

TABLE 4
Tg calculations

| Comonomer | Tg |
|---|---|
| (% EA) Level | (° C.) |
| 5 | 95.7 |
| 12 | 83.4 |
| 18 | 73.5 |
| 25 | 62.6 |

What is claimed is:

1. A die-cuttable acrylic sheet comprising:
a) from 40-60 percent by weight of an acrylic matrix copolymer comprising at least 60 percent by weight of methyl methacrylate units and 4-40 percent by weight of at least one C₁₋₈ straight chain or branched alkyl (meth)acrylate; and
b) from 40 to 60 percent by weight of at least one impact modifier;
wherein the Tg of the acrylic matrix copolymer is from 70° C. to 86° C.

2. The die-cuttable acrylic sheet of claim 1 wherein the Tg to the acrylic matrix copolymer is from 74° C. to 84° C.

3. The die-cuttable acrylic sheet of claim 1 wherein said matrix copolymer comprises from 12 to 18 percent by weight of ethyl acrylate units and 82 to 88 percent by weight of methyl methacrylate units.

4. The die-cuttable acrylic sheet of claim 3 wherein said matrix polymer comprises 13 to 17 percent by weight of ethyl acrylate units.

5. The die-cuttable acrylic sheet of claim 1, wherein said matrix polymer has a molecular weight of from 50,000 to 250,000 daltons.

6. The die-cuttable acrylic sheet of claim 5 wherein said matrix polymer has a molecular weight of from 100,000 to 190,000 daltons.

7. The die-cuttable acrylic sheet of claim 1 wherein said impact modifier comprises a block copolymer formed by a controlled radical polymerization process.

8. The die-cuttable acrylic sheet of claim 1 wherein said impact modifier is a multi-stage core-shell impact modifier.

9. The die-cuttable acrylic sheet of claim 8 wherein said core-shell impact modifier contains at least 3 stages, having an intermediate elastomeric stage comprising 30-45 percent by weight of said core-shell impact modifier.

10. The die-cuttable acrylic sheet of claim 8 wherein said impact modifier has an average particle size of less than 150 nm.

11. The die-cuttable acrylic sheet of claim 8 wherein said impact modifier has an average particle size of from 150 to 450 nm.

12. The die-cuttable acrylic sheet of claim 1 wherein said sheet is formed by a melt extrusion process.

13. The die-cuttable acrylic sheet of claim 1 wherein said sheet is formed by a cast process.

14. The die-cuttable acrylic sheet of claim 1 wherein said sheet has a thickness of from 0.003 to 0.177 inches thick.

15. The die-cuttable acrylic sheet of claim 1 wherein said sheet has a thickness of from 0.020 to 0.125 inches thick.

16. The die-cuttable acrylic sheet of claim 1 wherein said sheet further comprises at least one additive selected from the group consisting of anti-oxidants, UV absorbers, dyes, colorants, and lubricants.

17. The die-cuttable acrylic sheet of claim 1 comprising an article formed by in-mold-decorating, a general purpose article, a point of purchase article, a fixture, a marine glazing, a snow mobile windscreen, or a sign.
